(19) United States
(12) Patent Application Publication
(10) Pub. No.: US 2026/0221904 A1
(43) Pub. Date: Jul. 30, 2026

(54) DESIGN AND METHODS FOR ELECTROSTATIC GOVERNOR

(71) Applicant: ESTAT Actuation, Inc., Pittsburgh, PA (US)

(72) Inventors: Kirby A. Witte, Pittsburgh, PA (US); Stuart B. Diller, Pittsburgh, PA (US); William S. Lesso, Pittsburgh, PA (US)

(73) Assignee: ESTAT Actuation, Inc., Pittsburgh, PA (US)

(21) Appl. No.: 19/146,072

(22) PCT Filed: Jan. 5, 2024
(86) PCT No.: PCT/US2024/010593

§ 371 Date: Jul. 7, 2025

Related U.S. Application Data
(60) Provisional application No. 63/437,272, filed on Jan. 5, 2023.

(51) Int. Cl. H02N 13/00

(52) U.S. Cl. CPC H02N 13/00

(57) ABSTRACT

An electrostatic brake or governor uses electrodes separated by a dielectric material and a power supply to affect motion-resisting torque. The power supply can be charged by energy harvesting elements on the brake/governor. In one example, inductively coupled coils, one on a rotating component and one on a stationary component, are used at the energy harvesting device to charge the power supply. Various control methods are used to modulate the motion-resisting torque, some of which can use the relative motion of the components to generate the driving power and to affect the control signals.

### CROSS-REFERENCE TO RELATED APPLICATION

This application claims the benefit under 35 U.S.C. § 119 of U.S. Provisional Application Ser. No. 63/437,272, filed on Jan. 5, 2023, which is incorporated herein by reference.

### STATEMENT REGARDING FEDERALLY SPONSORED RESEARCH

Not applicable.

### BACKGROUND

Governors and brakes are used in a multitude of applications where limiting the speed or stopping the rotation of a component is desired. They are used in small engines and generators, various safety mechanisms, as a means of limiting automated processes, and similar applications. Most governors/brakes need to be engaged/disengaged based off the rotational speed of the components being controlled. Contemporary devices are usually either purely mechanical, or electromagnetic devices that require external power.

Mechanical governors and brakes may be bulky, heavy, and exhibit undesirable wear characteristics. Electromagnetically activated governors and clutches require some sort of control electronics, which are often external, and a power source, which is almost always external. For devices that require external control, rotational speed is most often sensed with the use of encoders, inductive sensors, magnetic sensors, resolvers, etc. In addition, the power requirements and parasitic losses of some of the current governor/brake implementations may be undesirably high.

In some applications, power-off activation of a brake or governor is desired for operational or safety reasons. For example, in the case of a power loss an angled conveyor belt could lock or have self-governed velocity-limited descent of items on the belt to prevent uncontrolled descent of items on the belt, which could harm the items or people in the vicinity. This can be achieved with spring-loaded electromagnetic brakes, however these devices are large, heavy, and have high constant power consumption during normal operation in order to remain disengaged. Many robotics applications, including mobile robots, medical robots, and logistics robots require this functionality and are particularly motivated to reduce the size, weight, and power consumption of mechanical components.

Some components and configurations of existing electrostatic brakes and clutches place limitations on use in these applications. Using slip rings or brushes is disadvantageous in the electrostatic clutch application and other applications because the contact components wear over time, limiting the lifetime of the whole device and creating dust and particles that can contaminate other parts of the assembly such as the bearing or the electrostatic clutch interface. Slip rings and brushes can also be specialized and expensive to accommodate high voltage in the range of 50-1000 Volts. Slip rings and brushes that are commercially available are most often designed to transmit high currents in the range of 1-10 Amps, which is much higher than required by electrostatic clutches and requires large contact components, meaning that both in terms of voltage and current specifications brushes and slip rings are poorly suited to use in electrostatic clutches. Additionally, electrostatic clutch or brake electrical components that require continuous external power for operation are less suitable for applications that require activation during external system power loss events.

### BRIEF SUMMARY

Rotary electrostatic governors and brakes use electrically controllable electrostatic materials to engage/disengage one or more rotating components. They can transmit considerable torque for their size and weight, while consuming significantly less power compared to conventional electromagnetic clutches. They are comprised of at least two conductive surfaces or electrodes that can rotate relative to one another about a common axis, with a dielectric material between the surfaces. When a voltage differential is applied between the two conductive surfaces, electrostatic forces cause an attraction between the surfaces, resulting in physical engagement and torque transfer between the rotating components.

Disclosed herein is a self-contained electrostatic-based governor or brake that can be used to limit or stop the relative rotation between two or more objects or assemblies. Electrostatic clutches can have much higher torque-to-weight and torque-to-volume ratios than conventional clutch designs, as well as significantly lower power consumption. This low power consumption enables the electrostatic clutch to be powered by a small energy storage device or entirely by energy harvested from the larger mechanical system in which it operates. Specifically, the device may harvest this power from the relative rotation between the two sides of the clutch assembly. This can be achieved using small permanent magnets in one assembly to create a rotating magnetic field relative to winding coils in the other assembly, which converts the mechanical power to electrical power. This generated electrical power can be manipulated using a circuit to control the physical engagement of the electrodes of the governor/brake to produce the desired torque or damping that resists relative rotation. Other energy sources such as thermal gradients or vibrations may also be used.

A method of power transfer that may be used to power the electrostatic governor or brake is contactless energy transfer through inductively coupled coils. This method may also be used to transfer control signals to the rotating portion of the clutch assembly. The stationary coil can be driven with an alternating waveform which transmits power and control signals to the rotating receiving side. The ratio of wire turns between the two coils can provide a means of voltage boosting needed for the electrostatic clutch materials. The coils can eliminate the need for some brushes, slip rings, or other kinds of mechanically contacting power transfer.

Because electrostatic clutches use a relatively high voltage, but very small amount of current, the inductively coupled coils only need to transfer a minimal amount of power. This enables the use of smaller coils compared to a conventional electromagnetic clutch being driven in the same manner. The inductively coupled coils can also be more compact than a brush or slip ring, and can take on a form factor similar to that of electrostatic clutch electrodes, making design and integration more optimal.

### BRIEF DESCRIPTION OF THE SEVERAL VIEWS OF THE DRAWINGS

FIG. 1 depicts a cross-sectional view of the coil to magnet orientation in a generalized embodiment with radially oriented magnetic fields.

FIG. 2 depicts a cross-sectional view of the coil to magnet orientation in a generalized embodiment with axially oriented magnetic fields.

FIG. 3 is a graph depicting how the rectified voltage generated from the coil windings scales mostly linearly with the relative rotational speed between the coils and permanent magnets.

FIG. 4 is a graph depicting the relation between rectified coil voltage vs. relative rotational speed and the voltage applied to the electrostatic brake electrodes using a simple Zener diode based level-shift circuit.

FIG. 5 is a graph depicting the relation between rectified coil voltage vs. relative rotational speed and the voltage applied to the electrostatic brake electrodes using a transistor based circuit to engage at a set point.

FIG. 6 is a graph depicting the relation between rectified coil voltage vs. relative rotational speed and the voltage applied to the electrostatic brake using a latching circuit.

FIG. 7 depicts the constituent systems and the flow of power and voltage from the power loss-resistant energy source through the control circuit to the electrostatic governor/brake.

FIG. 8 depicts an embodiment where the power loss-resistant energy source is a local battery or capacitor that is intermittently charged by the power supply of the greater mechanical system containing the electrostatic governor/brake.

FIG. 9 depicts an embodiment where the power loss-resistant energy source is a local battery or capacitor that is intermittently charged by an energy harvesting device.

FIG. 10 depicts the embodiment where the power loss-resistant energy source is a local battery or capacitor that lasts for the lifetime of the greater system or is intermittently charged from an external source or swapped out.

FIG. 11 depicts the embodiment where the energy harvesting device directly powers the circuit and clutch with no intermediate energy storage device to buffer the power.

FIG. 12 depicts an embodiment of electrostatic clutch.

FIG. 13 depicts a generalized overview of the major components that may comprise an electrostatic clutch utilizing inductively coupled coils for power and data transfer.

FIG. 14A depicts a cross-sectional view of one possible implementation of an electrostatic rotary clutch utilizing inductively coupled coils. The two coils are depicted as being concentrically oriented in relation to one another in this instance.

FIG. 14B depicts a similar cross-sectional view of an implementation of an electrostatic rotary clutch including electrically floating electrostatic brake electrodes mechanically attached to “Shaft B.” The electrostatic brake electrodes mechanically attached to “Shaft A” are electrically driven in two sets of opposite polarity from the receiver-side electronics.

FIG. 15 is a graph depicting the general relationship between the input waveform driving the transmitting coil on the top half, and the output waveform from the receiving coil on the bottom half.

FIG. 16 is a graph depicting an example of FSK modulation of the transmitting coil waveform on the top half. The bottom half depicts how the switching frequency data is interpreted by the receiver-side electronics after demodulation.

FIG. 17 is a graph depicting the generalized relation between the active duty-cycle of the transmitting coil and the rectified output voltage level from the receiving-side coil.

### DETAILED DESCRIPTION

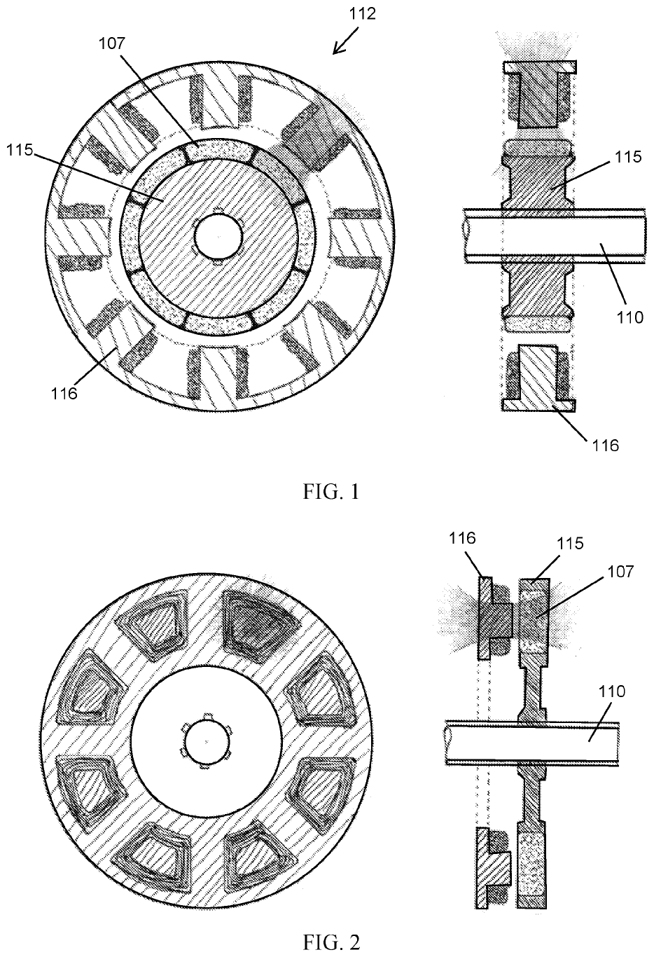

According to embodiments of this disclosure are methods for powering and controlling an electrostatic device 100, such as a clutch, brake, or governor. One embodiment of an electrostatic brake/governor 100 is shown in FIG. 1. In this embodiment, the electrostatic brake/governor 100 comprises two electrodes 102 separated by a dielectric material 103. A simplified depiction of this governor/brake 100 is shown in FIG. 12. As shown in FIG. 12, a controller or electric circuit 106 is used to create a voltage differential between the two electrodes 102, creating an electrostatic charge between the two which results in an attractive force between the electrodes 102. The dielectric material 103 prevents a shorting between the two electrodes 102, even upon contact. In normal operation (i.e. disengaged state), the two electrodes 102 may be separated by a small air gap, but contact each in an engaged state.

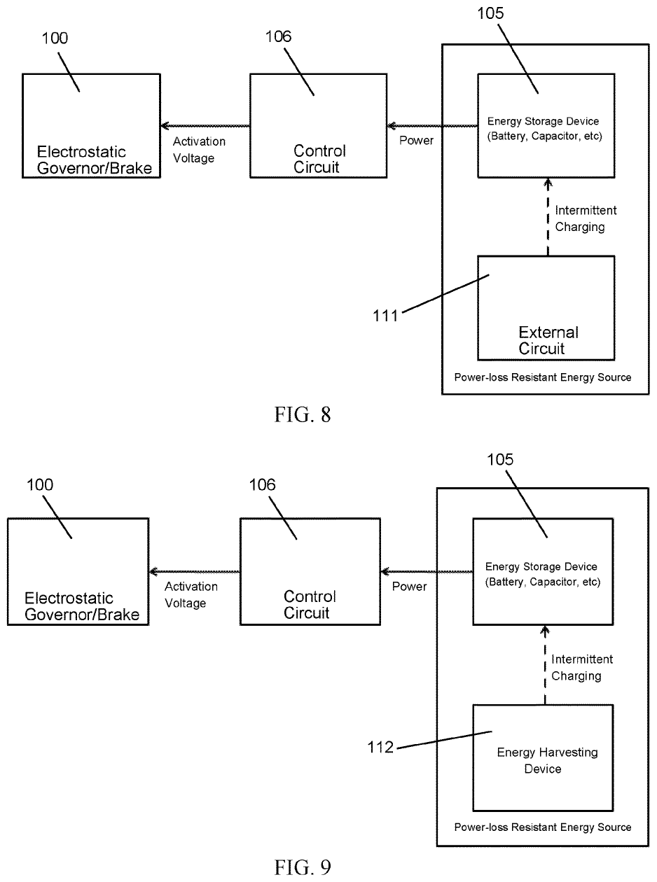

Electrostatic governors and brakes 100 consume very small amounts of power, and this disclosure describes multiple methods to provide power that have substantial advantages but that might not in some cases be capable of providing enough power to a conventional power-on activated clutch, brake or governor. For example, the electrostatic device 100 can be powered by a small, local energy source 105, such as a battery or capacitor, which could be charged periodically by an external circuit 11 of a greater mechanical system 110 connected to the device 100 during normal operation (see FIG. 8). The required power can alternatively be taken directly from a speed-sensing portion of the governor/brake 100, or from another source of energy from the environment or greater mechanical assembly like vibration or thermal gradients (see FIG. 11).

In some applications, the energy source 105 and circuit 106 may only need to be capable of delivering enough energy for a single charge of the electrodes 102. This is because the electrodes 102 have the electrical properties of a capacitor, meaning that the initial applied voltage and electrical charge may be maintained in the electrodes 102 for extended periods of time (up to minutes or hours) depending on the leakage current through the dielectric 103. This property may also be tuned by changing the dielectric material 103, interface area of the electrodes 102, parallel resistance in the circuit 106, parallel capacitance in the circuit 106, and other methods, in order to achieve brake discharge and release in a desired time window.

Additionally, the slipping and damping properties of the device 100 may also be tuned by mechanical design choices or electrical design choices to enable controlled descent or relaxation of a greater mechanical system 110 with only a single device charge after a power loss. The greater mechanical system 110 can be defined as a robot, machine, or other mechanical structure that the electrostatic brake or governor 100 is used within. An external circuit 111 can be defined as a circuit, distinguished from the electrostatic brake/governor circuit 106, that is primarily used for purposes other than powering or controlling the electrostatic brake/governor 100. The external circuit 111 may intermittently power or control the electrostatic brake circuit 106 or energy source 105. In some embodiments the greater mechanical system 110 has a central power source or controller that functions as the external circuit 111.

One embodiment of the electrostatic brake/governor circuit 106 includes a voltage transformer, a set of relays or mosfets for controlling voltage applied to the circuit 106, and a high-voltage capacitor. One embodiment of the external circuit 111 includes a low voltage power supply, a computer, and motor control circuitry, and a digital or analog communication line and a power line connecting it to the brake/governor circuit 106. The time for which the brake 100 remains engaged can be increased by increasing the parallel capacitance, decreasing or eliminating parallel resistance, and by increasing the electrical resistivity of the dielectric insulator material 103. The damping properties of a controlled electrostatic governor 100 may be similarly determined using the method of changing the electrostatic brake/governor circuit 106, energy harvesting device 112, or dielectric material 103. These properties may be pre-set for a single pre-determined behavior, or some of these properties can be changed in real-time using variable resistors, variable capacitors, or by changing the proportion of electrode area connected to the activation voltage.

The brake disengage time and damping properties can also be controlled by a digital control device as a part of the brake/governor circuit 106 operating with open-loop or closed-loop control. In some embodiments, open-loop control is used to control a brake property using a pre-determined relationship between some control parameter and the output property. In one open-loop control embodiment, a variable or fixed value resistor is set to a value that is known to result in a desired brake disengage time. In some embodiments, closed-loop control is used to control a brake property by measuring a property and adjusting the control parameter in real time to achieve the desired property value. In some embodiments, the brake property may be the brake voltage or torque. In some embodiments, the control parameter may be brake current or voltage. In one closed-loop control embodiment, a particular damping torque is produced by the electrostatic clutch 100 by actively measuring the torque and increasing or decreasing the voltage applied to the clutch 100 to achieve and maintain the desired torque value.

In an embodiment where a speed-sensing electromagnetic component is used for energy generation, the multifunctional speed-sensing/power-generating components can be incorporated integrally into the device 100 itself. Permanent magnets 107 can be affixed to one portion/assembly of the device 100, which during relative rotation, will pass by appropriately placed coils in the other portion/assembly 100. The electromagnetic field generated voltage from the coils will generally form a close to linear relation to the relative rotational speed of the magnets. This can be taken advantage of for control purposes, allowing either an incremental engagement of the electrostatic electrodes 102, like a governor, or simply a distinct full engagement point like a brake. In the simplest embodiments, the controlling electronics are comprised of relatively few electrical components with low cost. Using this method to power the circuit 106 responsible for controlling and applying voltage to the electrostatic governor/brake 100 can allow the system to operate in some cases without a dedicated energy source 105, without an external power source, and/or without a hard-wired electrical connection to the greater mechanical system 110.

In one embodiment, the device 100 comprises the electrostatic clutch electrodes 102, dielectric 103, and any associated mechanical and electrical attachments, an electromagnetic energy harvesting system 112 which may comprise permanent magnets 107 affixed to the one shaft or rotating assembly 115, appropriately wound coils affixed to the other portion 116 to generate an AC voltage from the rotating magnets, and a control circuit 106 to rectify and apply the voltage to the electrodes 102 in the desired manner. Herein, these portions are referred to as the inner assembly 115 and the outer assembly 116, or as assembly A and assembly B.

Depending on the application, only one assembly 115/116 may be rotating and the other fixed, or both may be rotating. The voltage generated and engagement characteristics only depend on the relative rotational speed between the two assemblies 115/116. In some embodiments it may be desirable to have the coils along with the electronics in the portion that is usually rotating, and the magnets in the other. The permanent magnets 107 are attached to one portion of the brake/governor device 100, so that they produce a corresponding rotating magnetic field relative to the coils housed in the other portion during relative rotation. They may be arranged so that the orientation of the magnetic field interacting with the coils occurs in either a radial or axial direction relative to the shaft axis.

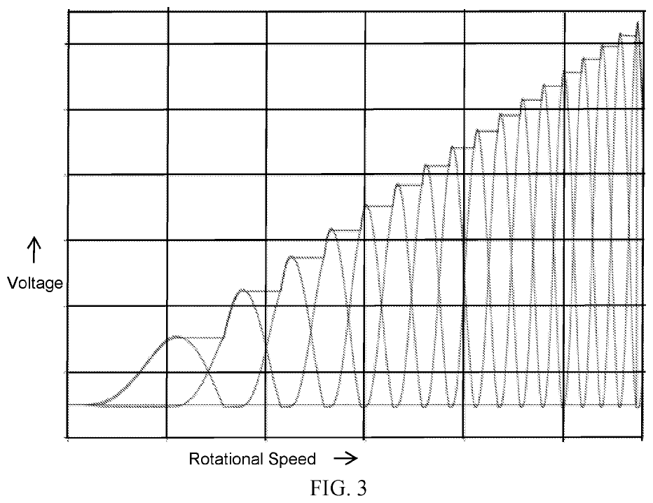

A radial configuration is depicted in FIG. 1, and an axial configuration in FIG. 2. These magnetic field and coil configurations are analogous to radial flux and axial flux brushless motors. A high magnetic permeability material may be used in the cores of the coils to alter field properties and magnetic flux linkage. In some embodiments, the voltage generated will scale mostly linearly with rotational speed. This relationship is illustrated in FIG. 3. The ratio of generated voltage vs. rpm will depend on, and may be tuned/altered by, multiple factors. In some embodiments with relatively low rotational speeds, the ratio may be in the range of 0.1 Volt/RPM to 10 V/RPM. In other embodiments with relatively high rotational speeds, the ratio may be in the range of 1 mV/RPM to 100 mV/RPM. The strength and size of the magnets will affect the voltage ratio. How well the magnetic flux is linked between the magnets and coils will have an effect. Multiple coils may be connected in either series or parallel for different voltage/current generating characteristics. The number of turns in the coils has the potential to have the most effect and may be the primary means of controlling the relationship between voltage and rpm in most embodiments.

In some situations, a relatively high voltage vs. rotational speed ratio may be needed. Such a high ratio may be impractical using solely the rectified peak voltage generated from the coils. In these situations, a small transformer or transformers may be situated between the AC outputs from the coils and the rectification diodes.

Another possible configuration for generating higher voltage vs. rotational speed ratios is using a capacitive charge-pump circuit. Again, the low power requirements of the electrostatic brakes/governors 100 fit advantageously with the high-voltage/low-current characteristics of a charge-pump voltage multiplier.

Finally, some form of circuit that takes advantage of the inherent inductance of the coils may be used to further multiply the voltage. This can be accomplished by abruptly disrupting the current flow in the coils, causing a proportional voltage spike, similar to a boost or flyback converter.

The generated and rectified voltage from the coils can charge a DC reservoir capacitor. The size of this capacitor will have an impact on the responsiveness and duration of the engagement, and is selected along with parallel resistance values to produce the desired clutch discharge properties according to the application.

Brake/governor activation can be accomplished using a relatively small number of simple and robust electrical components. In one embodiment, the voltage generated by the energy harvesting device 112 is applied directly to the electrodes 102 of the electrostatic brake/governor 100. In another embodiment, the rectified voltage is applied through a Zener diode in series so that no voltage is applied to the electrostatic electrodes 102 until a certain speed threshold, then the voltage scales linearly from zero. This activation method is depicted in FIG. 4.

In one embodiment, a switching semiconductor (BJT, Mosfet, IGBT, etc.) is driven with a level-shifted voltage from the generated DC voltage. As previously described, this can be accomplished with a simple Zener diode-based circuit. The Zener voltage can be chosen to adjust the rotational speed at which the electrostatic brake 100 engages. For higher voltages, multiple Zener diodes may be placed in series.

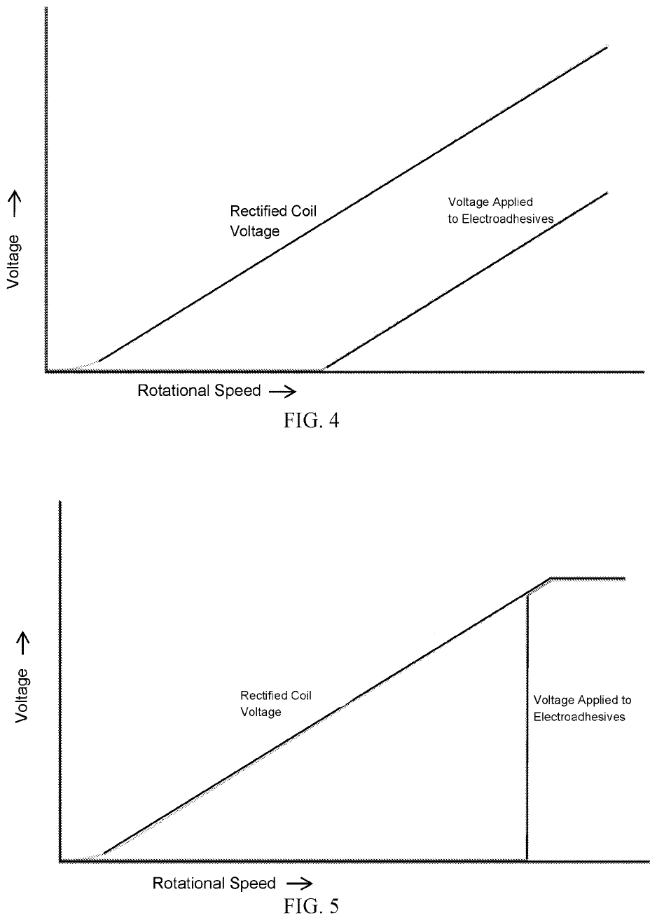

In one embodiment of this circuit using an N-channel Mosfet as the switching semiconductor, the Mosfet may be connected in series with the electrostatic components, between the rectified DC voltage, acting as a low-side switch. The gate of the Mosfet would then be connected to the positive supply with a Zener diode of the appropriate Zener voltage. The gate would also have a bias current resistor to the negative supply to adequately bias the Zener diode. An additional, lower voltage Zener diode may be connected in parallel with this resistor to limit the maximum gate-to-source voltage to a level that will not damage the Mosfet. This Zener pair would also limit the maximum voltage across the electrostatic electrodes 102. Once the rotational speed reaches a level where it generates a voltage that is equal to the Zener voltage plus the gate threshold voltage of the Mosfet, the Mosfet will begin conducting and engage the electrostatic brake 100. This control method is depicted in FIG. 5.

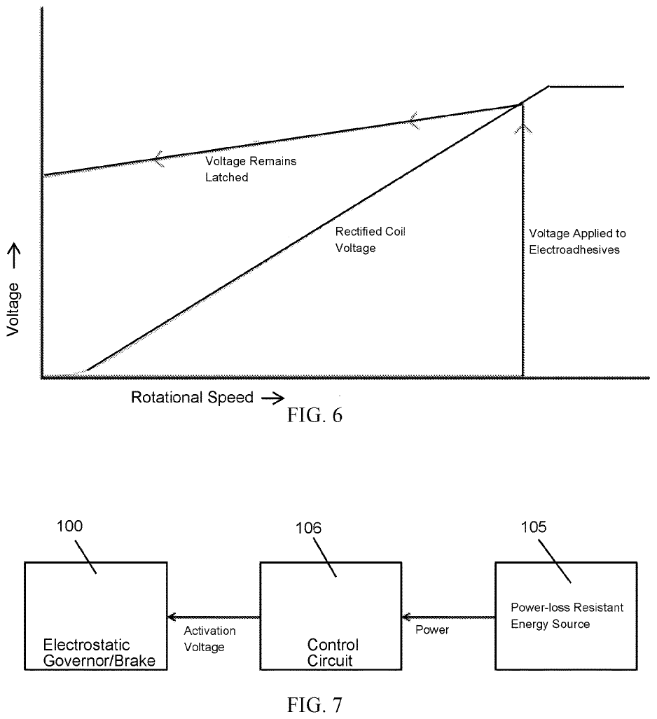

Other embodiments of the control circuitry 106 are possible. One may be implemented where a circuit 106 similar to the previous example also has a relatively large reservoir capacitor across the rectified DC voltage. A latching circuit would control the Mosfet's gate to keep the Mosfet engaged for an appropriate amount of time once the Zener threshold voltage triggers the latching circuit. The large capacitance of the reservoir capacitor compared to the capacitance and leakage current of the electrostatic brake 100 can provide an engagement voltage after the rotation significantly slows or stops. This is depicted in FIG. 6. (Once the trip point is reached, the voltage from the reservoir capacitor is applied. Significant voltage remains applied to the electrostatic brake even after the governor/brake slows down or stops.)

There are many other possible implementations of the control/engagement circuitry 106, and the previous examples are not exhaustive.

In one embodiment, the device 100 comprises electrostatic clutch electrodes 102, dielectric 103, and any associated mechanical and electrical attachment; a local battery, capacitor, or other energy storage device 105; and a control circuit 106 to apply the voltage to the electrodes 102 in the desired manner. The flow of power is charted in FIG. 7. The local energy storage device 105 enables use of the circuit 106 in the case of main power loss in the greater mechanical system 110. In the case where a local battery 105 is used, the local circuit battery 105 can be charged by an attachment to the power supply of the external circuit 111 of the greater mechanical system 112 periodically or continuously during the course of normal operation (as shown in FIG. 8). In the case where main power is lost in the greater mechanical system 110 or the connection between main power and the local battery 105 is lost, the electrostatic brake/governor/clutch 100 can still operate. A capacitor can similarly be used to store energy (i.e. act as an energy source 105) used to activate the device 100, and can be charged directly from the main power supply or through a small voltage transformer circuit.

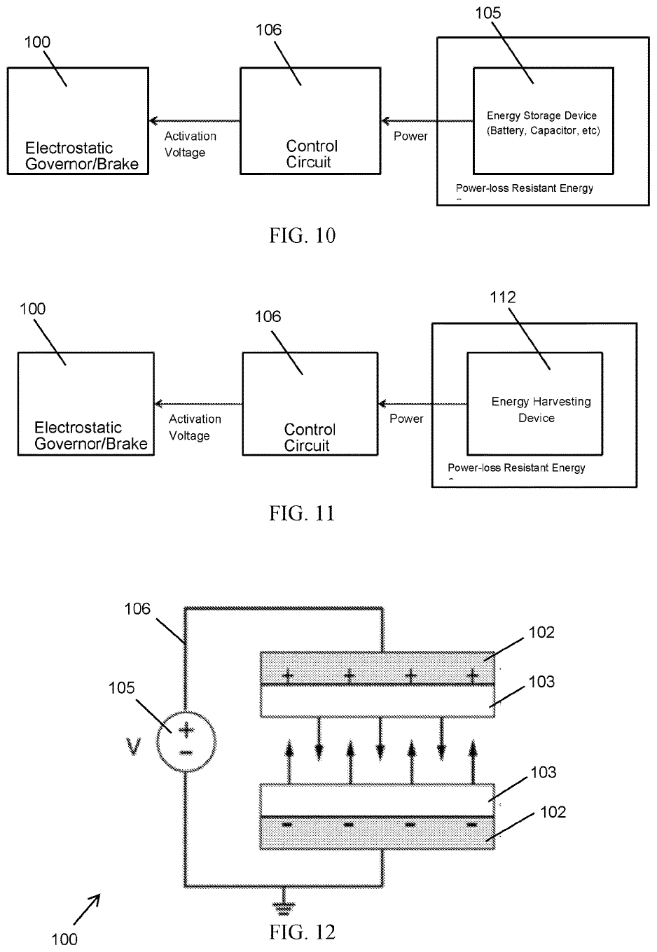

Whether a battery, capacitor, or both are used as an energy source 105, the circuit 106 can be configured to discharge the energy directly into the electrostatic brake/governor 100 to activate it and produce resistive torque in the case that power to the electrostatic brake/governor circuit 106 is lost. This could be achieved by configuring a Mosfet or relay to isolate the electrostatic device 100 from the activation voltage when a voltage is applied to the gate, and to revert to a default low-resistance voltage pathway between the electrostatic device 100 and the activation voltage when the gate voltage is 0. In another embodiment, the energy storage device 105 can be sized to provide long-term circuit and clutch functionality (see FIG. 10).

In one embodiment, the energy storage device 105 is periodically charged from an external source, or the energy storage component is periodically replaced. In other embodiments a local battery or capacitor may be able to last for the useful life of the electrostatic brake/governor 100. In one embodiment, an energy harvesting device 112 is included which constantly or periodically charges the energy storage device 105, which acts as a buffer of the energy and allows harvesting even when the device 100 is not desired to be engaged, or activation of the electrostatic brake/governor 100 when energy from the environment is not available (FIG. 9). In one embodiment the condition of energy generation correlates directly with the partial or full activation of the electrostatic clutch 100 (FIG. 11). An example of such an application is a mobile legged robot that freezes in place or slowly collapses to the ground when power is lost. In this case, initial rotation of the joints due to the weight of the robot causes energy generation and activation of the electrostatic brakes/governors 100 which then slow or halt joint rotation.

Inductively coupled coils are commonly used for contactless power transfer. They are found as wireless chargers in small electrical devices, such as cellphones and toothbrushes. They are also used for charging electric vehicles, powering passive RFID cards, and for some medical devices, among other applications.

In one embodiment, a coil 108 is used to transfer power. Since inductively coupled coils 108 transfer power through a magnetic field, no physical connection is needed between the one or more portions of the device 100 that rotate relative to a stationary portion. Control signals can be transmitted simultaneously with the power by modulating the AC waveform on the transmitter coil 108 to implement a frequency-shift keying or phase-shift keying scheme. The angular orientation of the rotating portion has no influence on the transfer of power or control signals. The driving coil 108, with its associated electronics, can remain stationary while the driven coil 108 can freely rotate with the portion of the device 100 that is in motion. This method allows the transfer of said power and/or control signals without physically contacting components, such as slip rings or brushes.

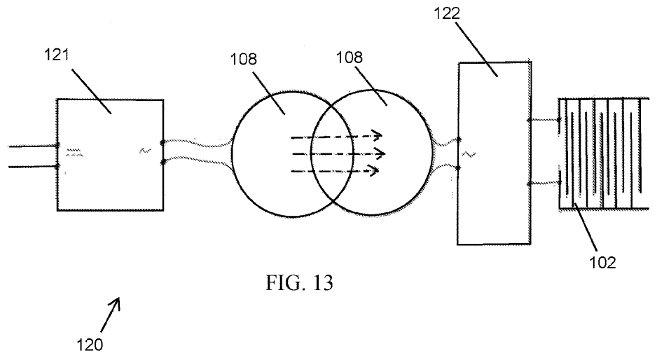

In one embodiment, inductively coupled coils 108 are employed with the electrostatic device 100 to transmit power to, transmit control signals to, and/or boost voltage to the brake, governor, or clutch 100. The main components of the coil assembly 120 comprise the transmitter-side control electronics 121, the transmitting and receiving coils 108, the receiver-side electronic components 122, and the electrostatic components, such as the electrodes 102, in addition to the supporting mechanical structure. One embodiment is outlined in FIG. 13. The transmitter-side electronics 121 take the low-voltage input DC power and modulate it according to externally generated control commands/signals, such as clutch engagement, electrostatic voltage setting, etc. They may be based primarily around a polarity switching circuit, such as some type of transistors/switches in an H-bridge configuration, along with their associated drive circuitry. Other components of the transmitter-side control electronics 121 include a microcontroller or other logic for control, auxiliary voltage regulators for the digital power rails, and the circuitry needed to interface with the external command signals, digital isolators, etc. One function of the transmitter-side electronics 121 is to output an AC waveform at the necessary frequency. This waveform is used to drive the transmitting coil 108, which creates the alternating magnetic field. The receiving coil 108 generates an alternating high-voltage from this field, which is fed into the receiver-side electronics 122. The receiver-side electronics 122 rectify this voltage, and if implemented, demodulate/decode the control signals conveyed with the switching frequency or phase relation. The demodulated signals can control further receiver-side circuitry if implemented. The high-voltage rectified, AC, or other waveform output from the receiver-side electronics 122 activates/deactivates the electrostatic components to engage/disengage the clutch 100 or control clutch transmission torque.

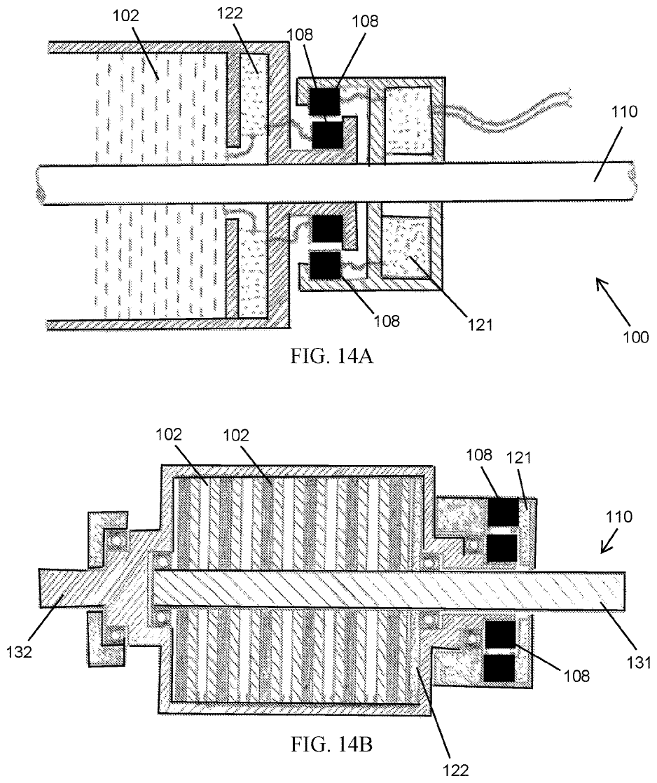

In rotating assemblies, one or more portions can be defined as the non-rotating or stationary portion. Herein, the stationary portion 132 refers to the portion that is on the side of inductive coupling that contains the transmitter control electronics 121. The stationary portion 132 may be static relative to a helpful coordinate system (such as fixed onto the main body of a robot), or it can be moving relative to the main coordinate system (such as fixed onto the arm of a robot) with a local power supply or another rotary electrical coupling or flexible wires connecting to the main power supply on the main coordinate system. Herein, the ‘receiving side’ refers to the portion that is on the other side of the inductive coupling from the transmitter control electronics 121. The transmitter control electronics 121 can be situated either incorporated into the stationary (non-rotating) portion 132 of the device assembly, or in a remote location and connected with wiring. The transmitting coil 108 may be wound cylindrically co-axial with the axis of rotation. It can remain stationary and affixed to the non-rotating portion 132 of the device assembly 100. The receiving coil 108 should be situated in a manner to effectively couple the magnetic field between the two coils 108. This may entail being cylindrically wound in a concentric manner with the transmitting coil 108, with either a larger or smaller diameter. A cross-sectional view of one embodiment using this configuration is depicted in FIG. 14A. Alternatively, it may be of the same or similar diameter, and positioned directly adjacent to the transmitting coil 108 along the center axis. The receiving coil 108 and receiver-side electronics 122 rotate with the rotating portion 131 of the device 100. These rotating-side components can be positioned strategically about the rotating access to reduce any vibrations caused by unevenly distributed inertia.

In some embodiments of the device assembly 100, where there are two rotating portions 131 that rotate both relative to each other and to the stationary portion 132, the inductively coupled coils 108 can remove the need for contacting electrical connections between the stationary 132 and rotating 131 portions. An example of this configuration would be a rotating input shaft, a normally rotating output shaft, and a stationary housing that provides the needed mechanical constraints for the shafts and means of attachment to external components. A brush/slip-ring may need to be included between the two rotating portions 131. In this embodiment, the coils 108 would replace the constantly rotating electrical connections, while the brush/slip-ring would be between the two portions that rarely rotate relative to one another, for example only during slip/disengagement, thus subjecting the brush/slip-ring to substantially lower wear.

It is also possible to engage the electrostatic brake 100 with a positive and negative voltage on either side of an electrically isolated portion that has the ability to balance positive and negative charges among its electrode surfaces. In this scenario, the need for brushes/slip-rings would be completely removed. A clutch in this configuration is depicted in FIG. 14B. The “Shaft B” electrodes 102 rotate with the right-hand shaft and are electrically isolated from any components external to Shaft B. The “Shaft B” electrodes 102 do connect electrically to one another in pairs or across all “Shaft B” electrodes 102. The electrodes 102 that rotate with “Shaft A” are electrically split in two groups. The voltage output from the receiver-side electronics 122 applies the appropriate +/−polarities to these two electrode groups for engagement.

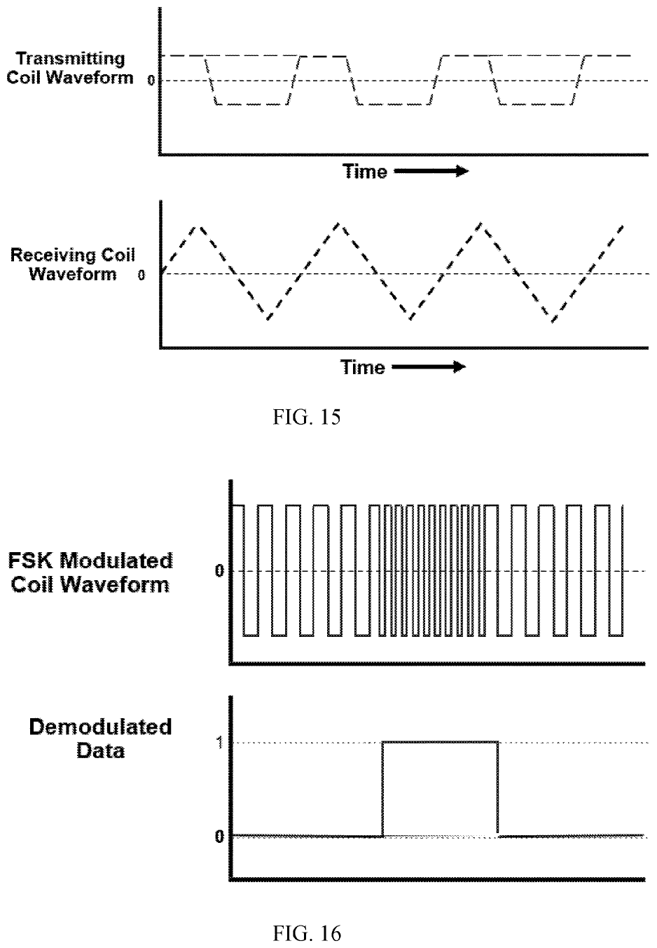

The clutch 100 may be engaged/disengaged by simply applying or not applying the appropriate AC waveform to the transmitting coil 108 from the transmitter control electronics 121. An example of the transmitting and receiving coils' waveforms under normal on-state switching is shown in FIG. 15. More advanced implementations may constantly have the transmitting coil 108 providing available power to the receiving coil 108, and the demodulated control signal from the receiver-side electronics 122 can activate a transistor or other circuitry integral to the rotating portion 131 to engage/disengage power to the electrostatic brake 100. During the disengaged state of this latter implementation only a minute leakage current would consume power. An example of the relationship between the modulated transmitting coil 108 waveform and the demodulated control signal on the receiving-side 122 using a Frequency-Shift Keying scheme is depicted in FIG. 15. Alternatively, a Phase-Shift Keying scheme may be implemented.

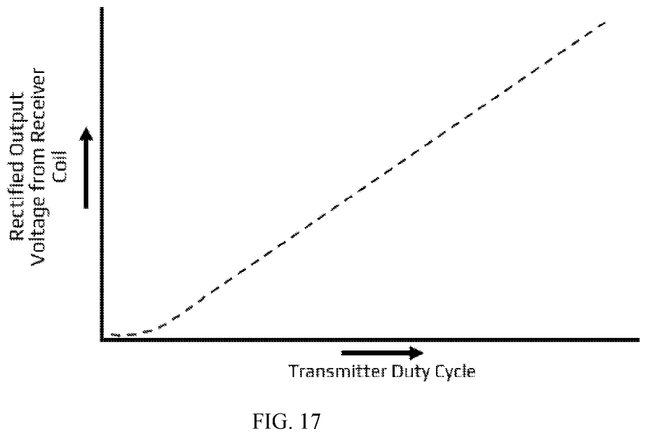

The transmitter control electronics 121 can alter the duty-cycle of the transmitting coil 108 to change the rectified output voltage from the receiving coil 108. A generalized relationship of rectified output voltage from the receiving coil 108 vs. effective duty-cycle on the transmitting coil 108 is depicted in FIG. 17. Alternatively, because of the non-linear relationship between frequency vs. power-transfer ratio between the two coils 108, altering the transmitting coil's excitation frequency can change the rectified output from the receiving coil 108 in certain embodiments. Either method may be used to alter the voltage applied to the electrostatic elements, such as the electrodes 102, thus altering the torque transferring capability of the device 100. Furthermore, the transformer-like relation between the winding ratio of the two coils 108 can be taken advantage of. A high receiver-to-transmitter winding ratio allows the simultaneous transfer of controlled power while also boosting a lower voltage input on the transmitting coil 108 into a higher voltage, but lower current output on the receiving coil 108. This eliminates the need to incorporate some other form of step-up circuitry, such as a boost or flyback converter.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. In particular, one or more features in any of the embodiments described herein may be combined with one or more features from any other embodiments described herein.

Protection may also be sought for any features disclosed in any one or more published documents referred to and/or incorporated by reference in combination with the present disclosure.

What is claimed is:

1. An electrostatic device comprising:
at first electrode and a second electrode;
a dielectric material disposed between the first electrode and the second electrode;
an energy source for supplying intermittent power to the first electrode and the second electrode; and
a circuit that controls a flow of power to the first electrode and the second electrode.

2. The electrostatic device of claim 1, wherein the energy source is selected from a group consisting of an energy harvesting device, a battery, a capacitor, a coil generator, and a thermoelectric or light converting device.

3. (canceled)

4. (canceled)

5. The electrostatic device of claim 1, wherein the circuit is an analog circuit or a digital circuit.

6. (canceled)

7. The electrostatic device of claim 1, further comprising:
a mechanical system attached directly or indirectly to at least one of the first electrode and the second electrode,
wherein the circuit is configured to controllably lock or damp the mechanical system in response to a movement of the mechanical system.

8. (canceled)

9. The electrostatic device of claim 2, wherein the energy harvesting device comprises:
a vibrational energy harvester selected from a group consisting of a piezoelectric, electromagnetic, electrostatic and triboelectric vibrational energy harvester.

10. (canceled)

11. The electrostatic device of claim 2, wherein the battery is periodically charged by an external circuit connected to the energy source or the circuit.

12. The electrostatic device of claim 2, wherein the battery is charged using energy from an energy harvesting device.

13. The electrostatic device of claim 2,
wherein the capacitor is periodically charged by an external circuit connected to the energy source or the circuit,
wherein the external circuit provides energy during operation of a mechanical system attached directly or indirectly to at least one of the first electrode and the second electrode.

14. The electrostatic device of claim 2, wherein the capacitor is charged using energy from an energy harvesting device.

15. The electrostatic device of claim 5, wherein the circuit causes a motion-resisting torque to be produced by the first electrode and the second electrode, wherein the torque is based on a velocity, an acceleration, a position, or another characteristic of a mechanical system attached to the first electrode or the second electrode.

16. The electrostatic device of claim 2, wherein the circuit causes a motion-resisting torque to be produced by the first electrode and the second electrode in response to a control signal.

17. The electrostatic device of claim 2, wherein the control signal is transmitted and received wirelessly.

18. The electrostatic device of claim 1, further comprising:
an external circuit for supplying power to the energy source,
wherein the circuit is configured to supply a voltage to the first electrode and the second electrode when a flow of power from the external circuit is terminated.

19. The electrostatic device of claim 18, further comprising:
a gate circuitry configured to cause power to flow to the first electrode and the second electrode from the energy source when a flow of power from the external circuit is terminated.

20. An electrostatic device comprising:
a first electrode;
a second electrode positioned proximate to the first electrode;
an inductive coil configured to transmit or receive power; and
a circuit that controls a flow of power to the first electrode and the second electrode.

21. The electrostatic device of claim 20, further comprising:
an additional inductive coil configured to transmit or receive power from the inductive coil.

22. The electrostatic device of claim 21,
wherein the inductive coil is connected to a non-rotating component attached to the first electrode,
wherein the additional inductive coil is connected to a rotating component attached to the second electrode.

23. The electrostatic device of claim 21,
wherein the inductive coil is connected to a rotating component attached to the first electrode,
wherein the additional inductive coil is connected to an additional rotating component attached to the second electrode.

24. The electrostatic device of claim 21,
wherein a winding of the inductive coil and additional windings of the additional inductive coil are unequal, resulting in a change in a magnitude of a transmitted voltage relative to an input voltage.

25. The electrostatic device of claim 21,
wherein the circuit applies a variable activation frequency or duty cycle to the inductive coil, resulting in a change in a magnitude of a transmitted voltage to the additional inductive coil relative to an input voltage.

26. The electrostatic device of claim 21,
wherein the circuit applies a variable voltage waveform to the inductive coil corresponding to a control signal, resulting in communication of the control signal to a portion of the circuit connected to the additional inductive coil.

27. The electrostatic device of claim 26, wherein the circuit employs a frequency shift, a phase shift, or another keying scheme.
